(19) United States
(12) Patent Application Publication
(10) Pub. No.: US 2006/0028433 A1
(43) Pub. Date: Feb. 9, 2006

(54) Universal serial bus keystroke generator switch

(76) Inventor: Wilbur L. Myrick, South Riding, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/195,896

(22) Filed: Aug. 3, 2005

Related U.S. Application Data
(60) Provisional application No. 60/598,761, filed on Aug. 4, 2004.

(51) Int. Cl. G09G 5/00

(52) U.S. Cl. 345/156

(57) ABSTRACT

An apparatus for producing signals that are representative of those produced by actuating a keypad on computer keyboard includes a momentary switch for energizing a USB microcontroller to produce a signal that complies with a USB protocol. The produced signals are inputted into a USB port on a CPU to be recognized as a single keystroke. An eight-output DIP switch connects to the USB microcontroller for varying the inputs to the microcontroller to change the signal produced by the microcontroller. The apparatus functions as a simple human, mechanical, or optical interface for generating signals representative of keystroke that are relayed to the CPU via a USB interface.

This application claims priority from U.S. Provisional Patent Application Ser. No. 60/598,761 filed on Aug. 4, 2004.

The patent application did not receive federal research and development funding.

### BACKGROUND OF THE INVENTION

The invention is generally directed to an apparatus that includes a switching device for generating signals that emulates signals representative of a keyboard character signal produced by striking a keypad on a standard computer keyboard. More specifically, the invention is directed towards an apparatus for inputting signals representative of keyboard characters into a universal serial bus (USB) connector on a central processing unit (CPU) of a computer using a single switch. The device is particularly useful in gaming applications. However, it should be recognized that it might be used in any instance where a single keyboard character is necessary for triggering a software program or routine.

Universal Serial Bus (USB) is a peripheral bus standard developed by the PC and telecom industry. USB defines a bus and protocols for the connection of computer peripherals to computers. Some types of USB devices include keyboards, mice, telephones, cameras, modems, joysticks, various types of drives, scanners, printers, MPEG products, data digitizers and other relatively low bandwidth devices. A USB port on a computer can both operate as a power source for devices connected to the USB port as well as a communications port for communicating between the computer and the connected USB device.

USB allows a user to dynamically insert and remove the aforementioned devices from the bus. When a device is connected, the USB recognizes and identifies the device. The device is forgotten upon removal from the USB. The USB specification requires the devices to be physically plugged in or removed from the bus in order to be recognized or forgotten.

### BRIEF SUMMARY OF THE INVENTION

The present invention provides a new and useful USB input device for keyboard character generation which is simple in construction, universally usable with different types of computers and more versatile in operation than known apparatuses.

The present invention provides a portable computer USB input device that yields a new, non-obvious computer input keyboard character generator device. The present invention generates keyboard characters for any type of computer via a USB port to function as an individual key of a computer keyboard. The present invention provides a simple human interface for generating keyboard characters that can be easily programmed to generate a variety of keyboard characters.

The present invention comprises a trigger switch that triggers a USB microcontroller to produce a USB protocol signal representative of a single keypad on a computer keyboard. When the trigger switch is actuated, the USB microcontroller produces a signal that emulates a keystroke signal. The emulated signal is routed back to the computer via a USB cable connecting the device to the computer. An eight-output DIP switch provides a programmable input into the USB microcontroller such that as the outputs of the DIP switch are varied, the signal representative of the keystroke that is produced by the USB microcontroller changes. A USB type A connector cable connects the apparatus to a computer via the USB port.

A principle object of the present invention is to provide a portable device to generate keyboard characters via the USB interface into a computer using a single switch that will overcome the deficiencies of prior art devices.

An object of the present invention is to provide a single mechanical or optical switch device that triggers the microcontroller to generate a keyboard character.

Another object of the invention is to provide a simple interface device that utilizes the USB interface to connect to a computer.

Another object of the present invention is to provide a connection of multiple devices that allow keyboard character generation of widely separated switches operating on the USB interface simultaneously.

Another object of the present invention is to provide a selectable eight-output DIP switch device that allows the keyboard character generator to generate any character of a keyboard via a USB interface.

Another object of the present invention is to provide a microcontroller device that generates the proper protocol that sends the keyboard character to a computer via a USB interface.

Another object of the invention is to provide an enclosure that encases the various parts that comprise the apparatus of the present invention.

A further object of the invention is to provide a portable device that is powered via the USB port on a computer.

Another object of the invention is to provide a single switch programmable keyboard input device that is universally functions with both PC and Apple® computers.

The above and further objects, details and advantages of the invention will become apparent from the following detailed description, when read in conjunction with the accompanying drawings.

### BRIEF DESCRIPTION OF THE DRAWINGS

FIG. 1A is a perspective view of the present invention. FIG. 1B shows a partial cutaway view of a casing of the apparatus shown in FIG. 1A and showing a removable printed circuit board (PCB) mounted within a case. FIG. 1C is a perspective view of the PCB removed from the case to allow a user to reprogram the microcontroller by changing the settings on a DIP switch.

FIG. 2A is a block diagram of the apparatus connected with the CPU of a computer. FIG. 2B is a block diagram of the device.

FIG. 3 is a schematic view of the apparatus.

FIG. 4 is a perspective view of another embodiment of the invention.

FIG. 5 is a perspective view of a further embodiment of the invention.

### DETAILED DESCRIPTION OF THE INVENTION

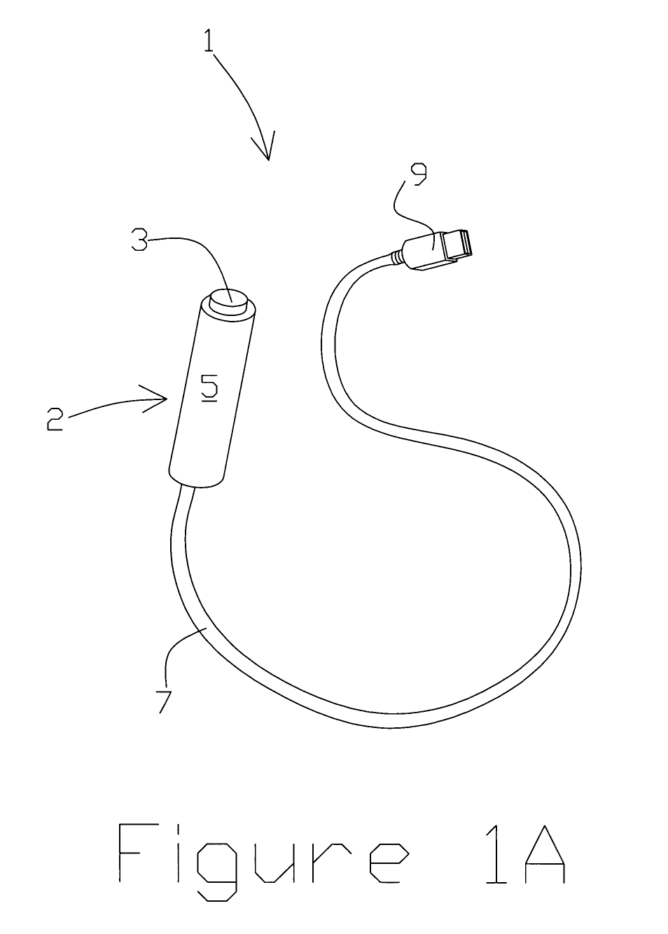

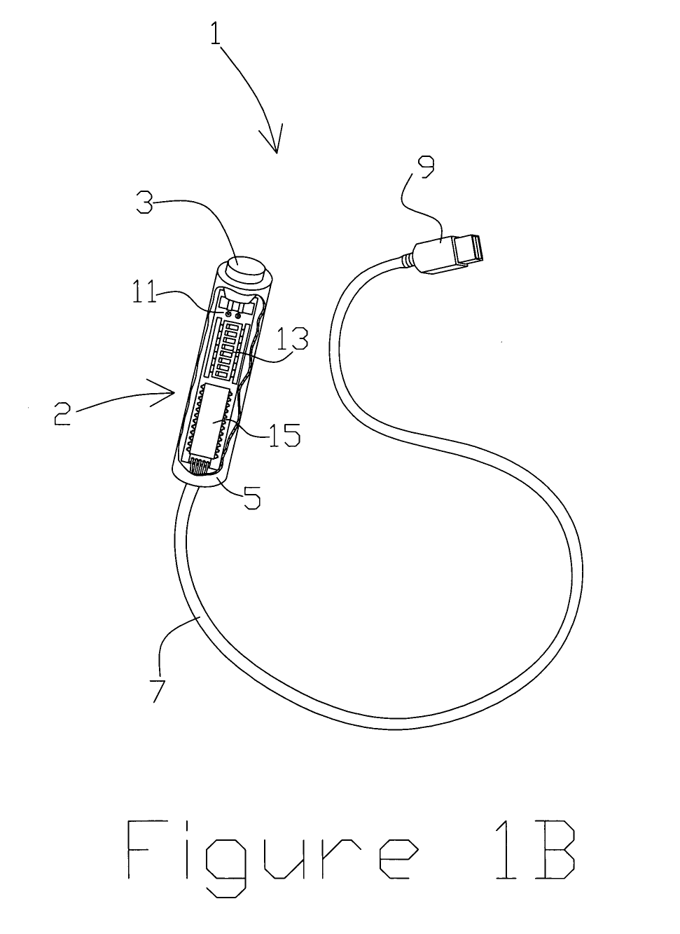

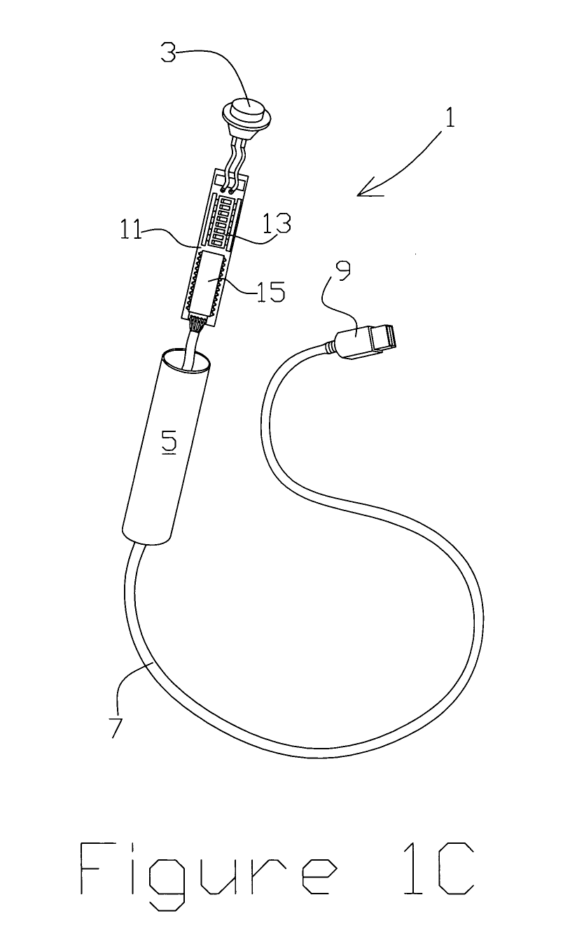

FIG. 1A is a perspective view of a first embodiment of the keystroke generator switch 1 that comprises a trigger switch 3 mounted in a handheld device 2. It should be noted that the trigger switch may be of any type including optically triggered switches, manually operated switches, relay switches or the like. In this embodiment, a hollow cylindrical case 5 is typically held in the hand of the user such that the momentary switch 3 may be activated with a thumb or finger of the user.

A USB cable 7 connects at one end to the handheld device 2. A USB series “A” plug is affixed at an opposite end of the cable 7 for coupling the generator switch 1 to a USB port on a computer. The USB cable 7 provides both power to the device and signals to the computer. In FIG. 1B, case 5 is shown cutaway to provide a view of the inner workings of the handheld device 2. Trigger switch 3 connects to a PCB 11. A DIP switch 13 and a USB microcontroller 15 are affixed to the PCB 11.

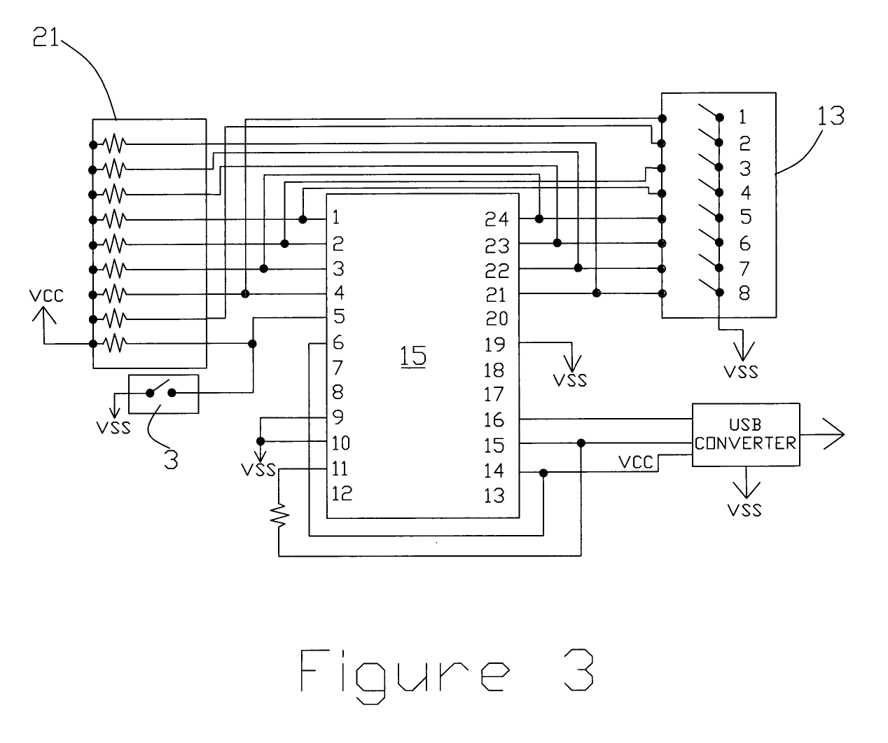

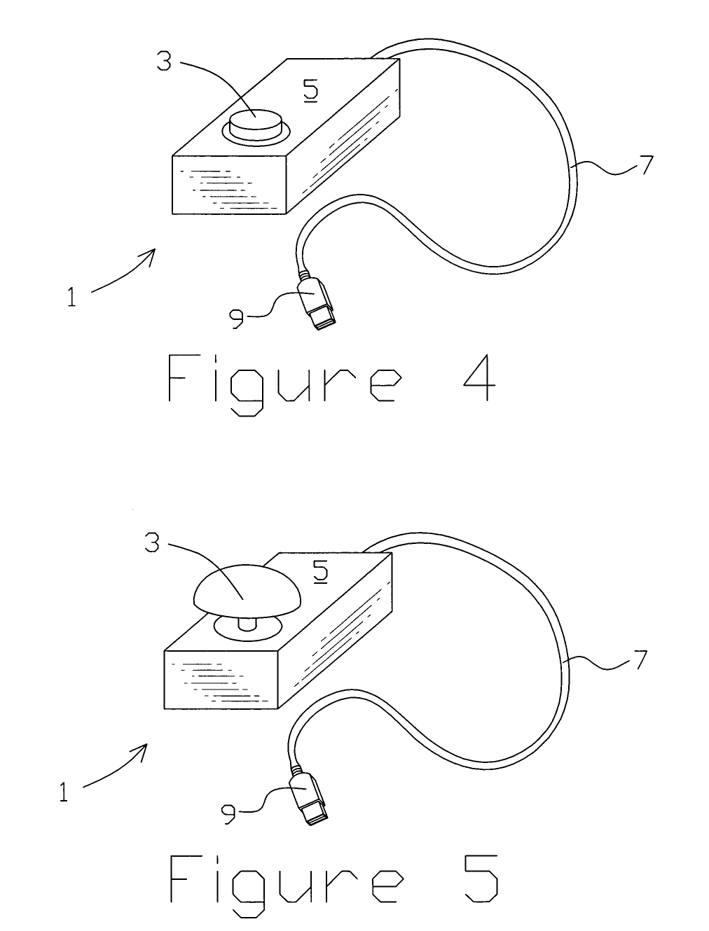

FIG. 1C depicts the PCB 11 and switch 3 as being removed from the case 5 for reprogramming purposes. Cable 7 passes through an opening (not shown) in an end of the case 5 and connects to the PCB 11. DIP switch 13 comprises eight input switches 14 that are connected to microcontroller 15 as more clearly shown in FIG. 3. Each of these input switches 14 provide either a “high” or “low” input into the microcontroller 15. By changing the input state of the switches, the microcontroller 15 may be reprogrammed to produce an output signal that emulates a different keystroke. The signal typically produced by the microcontroller 15 is an American Standard Code for Information Interchange (ASCII) signal that is then converted into a USB protocol signal and forwarded to the computer.

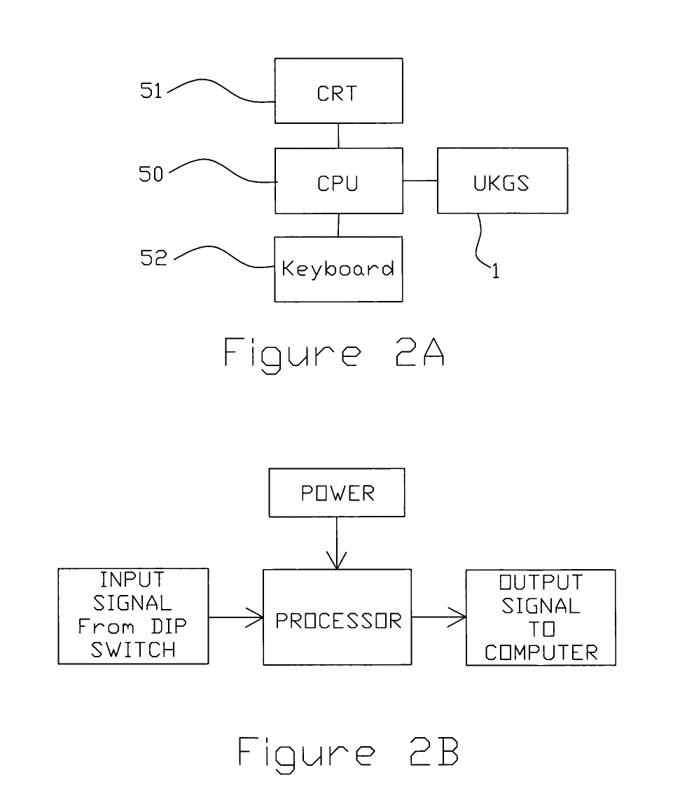

As shown in FIG. 2A, the apparatus 1 connects to a CPU 50 of a computer through a USB port. The apparatus is universal and may be used with all types of computers having a USB port. The apparatus 1 may be connected to the computer simultaneously with the screen 51 and keyboard 52. As shown in FIG. 2B, input signals from the DIP switch are continuously provided to the microprocessor 15. When the trigger is activated to the microprocessor from the trigger switch 3, the microprocessor produces an output signal that is routed to the CPU of the computer to be recognized as a keystroke.

FIG. 3 is a schematic view of the apparatus. The microcontroller 15 produces ASCII data which is easily converted to a USB protocol signal by a USB converter 25 prior to the signal being sent to the computer. A single in-line package of pull-up resistors, each resistor preferably having a 10 k ohm value, connects to the input lines, 1-4 and 21-24 of the microcontroller 15. Power is supplied to DIP switch 13 via Vₛₛ for continuously providing input signals to the microcontroller. When switch 3 is closed, microcontroller produces a signal that is output to USB converter 25. The signal is indicative of the state of each switch on the DIP switch. As can be easily recognized, by changing the states of the DIP switches, the state of the aforementioned inputs to the microcontroller may be varied to produce an output signal that differs. The output signal is then converted by the USB converter and passed on to the computer.

FIGS. 4 and 5 show different embodiments of the invention wherein the case 5 and the switch 3 are different in shape and size than those shown and discussed previously. In FIG. 4, the switch is a table-top embodiment. In FIG. 5, the switch is provided in a slap switch table-top embodiment. Both these embodiments are useful in gaming situations.

It is to be understood that the invention is not limited to the exact construction illustrated and described above, but that various changes and modifications may be made without departing from the spirit and the scope of the invention as defined in the following claims.

I claim:

1. A programmable USB keystroke generator switch comprising:
a trigger switch having an input and an output, said input receiving power from a USB port on a computer;
a USB microcontroller that generates an output signal that is input into said computer via the USB port, said output signal from the USB microcontroller being representative of a keystroke on a computer keyboard, said USB microcontroller having multiple inputs for use in producing a keystroke signal, the USB microcontroller being connected to said trigger switch such that when said trigger switch is actuated a keystroke signal is produced;
a DIP switch having a plurality of switches, each switch having an output and being individually connected to one of the multiple inputs of the USB microcontroller such that when a position of each switch is changed the input of the USB microcontroller connected to that switch changes the keystroke signal produced by the USB when the trigger switch is activated;
a USB converter for receiving the output signal produced by the microcontroller and converting it to a USB protocol signal to be forwarded to a computer; and,
a case for encapsulating at least the trigger switch.

2. The programmable USB keystroke generator switch of claim 1 further comprising a USB cable that includes a USB connector at one end and being connected to the USB converter at an opposite end.

3. The programmable USB keystroke generator switch of claim 1 further comprising USB type A connector.

4. The programmable USB keystroke generator switch of claim 1 wherein said case is a handheld case and said trigger switch is actuated by one of a finger and a thumb of a user.

5. The programmable USB keystroke generator switch of claim 1 wherein said case is a table top case.

6. The programmable USB keystroke generator switch of claim 1 wherein said trigger switch is slap switch.

7. The programmable USB keystroke generator switch of claim 1 further comprising a printed circuit board upon which said the switch and microcontroller are mounted.

8. A programmable USB keystroke generator switch comprising:
a trigger switch having an input and an output, said input receiving power from a USB port on a computer;
a USB microcontroller that generates an output signal that is input into said computer via the USB port, said output signal from the USB microcontroller being representative of a keystroke on a computer keyboard, said USB microcontroller having multiple inputs for use in producing a keystroke signal, the USB microcontroller being connected to said trigger switch such that when said trigger switch is actuated a keystroke signal is produced;
a DIP switch having a plurality of switches, each switch having an output and being individually connected to one of the multiple inputs of the USB microcontroller such that when a position of each switch is changed the input of the USB microcontroller connected to that switch changes the keystroke signal produced by the USB when the trigger switch is activated;
a USB converter for receiving the output signal produced by the microcontroller and converting it to a USB protocol signal to be forwarded to a computer;
a case for encapsulating at least the trigger switch; and,
a USB cable that includes a USB connector at one end and being connected to the USB converter at an opposite end.

9. The programmable USB keystroke generator switch of claim 8 wherein said case is a handheld case and said trigger switch is actuated by one of a finger and a thumb of a user.

10. The programmable USB keystroke generator switch of claim 8 wherein said case is a table top case.

11. The programmable USB keystroke generator switch of claim 8 wherein said trigger switch is slap switch.

12. The programmable USB keystroke generator switch of claim 8 further comprising a printed circuit board upon which said the switch and microcontroller are mounted.

13. A method for producing a signal that emulates a keystroke on a computer keyboard comprising:
producing a trigger signal by a trigger switch that receives power from a USB port on a computer;
providing a USB microcontroller that generates an output signal that is input into said computer via the USB port, said output signal from the USB microcontroller being representative of a keystroke on a computer keyboard, said USB microcontroller having multiple inputs for use in producing a keystroke signal, the USB microcontroller being connected to said trigger switch such that when said trigger switch is actuated a keystroke signal is produced;
providing a DIP switch having a plurality of switches, each switch having an output and being individually connected to one of the multiple inputs of the USB microcontroller such that when a position of each switch is changed the input of the USB microcontroller connected to that switch changes the keystroke signal produced by the USB when the trigger switch is activated;
providing a USB converter for receiving the keystroke signal produced by the microcontroller and converting it to a USB protocol signal to be forwarded to a computer; and,
providing a case for encapsulating at least the trigger switch.
